(19) United States
(12) Patent Application Publication
(10) Pub. No.: US 2026/0172151 A1
(43) Pub. Date: Jun. 18, 2026

(54) WIRELESS COMMUNICATIONS FEEDBACK

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Linhai HE, San Diego, CA (US); Yuchul KIM, San Diego, CA (US); Huilin XU, Temecula, CA (US); Zhikun WU, Beijing (CN)

(21) Appl. No.: 18/844,681

(22) PCT Filed: Apr. 8, 2022
(86) PCT No.: PCT/CN2022/085731

§ 371 Date: Sep. 6, 2024

(51) Int. Cl. H04L 1/1829; H04W 72/1268; H04W 72/232

(52) U.S. Cl. CPC H04L 1/1854; H04W 72/1268; H04W 72/232

(57) ABSTRACT

Certain aspects of the present disclosure provide techniques for wireless communication by a user equipment (UE), including transmitting an indication of a recommended minimum offset time, the recommended minimum offset time being a minimum time between transmission of feedback for a data transmission and scheduled reception of the data transmission; receiving one or more messages indicating one or more values configuring timing for transmission of first feedback for a first data transmission; and transmitting the first feedback based on the timing for transmission of the first feedback.

### BACKGROUND

### Field of the Disclosure

Aspects of the present disclosure relate to wireless communications, and more particularly, to techniques for feedback in wireless communications systems.

### Description of Related Art

Wireless communications systems are widely deployed to provide various telecommunications services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE), including transmitting an indication of a recommended minimum offset time, the recommended minimum offset time being a minimum time between transmission of feedback for a data transmission and scheduled reception of the data transmission; receiving one or more messages indicating one or more values configuring timing for transmission of first feedback for a first data transmission; and transmitting the first feedback based on the timing for transmission of the first feedback.

One aspect provides a method for wireless communication by a network entity, including receiving an indication of a recommended minimum offset time, the recommended minimum offset time being a minimum time between communication of feedback for a data transmission and scheduled communication of the data transmission; sending one or more messages indicating one or more values configuring timing for communication of first feedback for a first data transmission; and receiving the first feedback based on the timing for communication of the first feedback.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example time offset between a transmission and a feedback occasion.

FIG. 6 depicts an example process flow for communications in a network between a network entity and a user equipment (UE).

FIG. 7 depicts an example timeline for multiple configured feedback occasions for a scheduled transmission.

FIG. 8 depicts an example timeline including periodic feedback occasions for bundling feedback.

FIG. 9 depicts an example feedback timeline.

FIG. 10 depicts a method for wireless communications.

FIG. 11 depicts a method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for providing feedback in a wireless communications system. For example, certain aspects provide techniques for wireless communications devices having intermittent availability to communicate to be able to reliably provide feedback.

Certain wireless communications devices may have intermittent availability to communicate. For example, certain user equipments (UEs) may intermittently (e.g., unreliably) have sufficient power to be able to receive and/or transmit signals, including decoding and/or encoding the signals for communication. One type of UE that may intermittently have sufficient power may be referred to as an energy harvesting UE (EH-UE). An EH-UE may be used in a number of different applications, such as for passive Internet of Things applications, low energy applications, reduced capability (RedCap) applications, etc. An EH-UE is configured to opportunistically harvest energy from the environment, such as solar energy, heat energy, ambient radio frequency (RF) radiation, etc. For example, the EH-UE may have one or more suitable components for harvesting one or more different types of energy. The EH-UE may store harvested energy in a power storage component, such as a battery, capacitor, etc. The EH-UE may use the stored energy for wireless communications, such as to power RF components, such as an analog-to-digital converter (ADC), a digital-to-analog converter (DAC), a mixer, an oscillator, and/or the like. Accordingly, in certain aspects, an EH-UE may only be able to communicate in a wireless communications network at times that it has accumulated enough energy to communicate.

In certain aspects, wireless communications devices in a wireless communications system are configured to provide feedback (e.g., hybrid automatic repeat request (HARQ) acknowledgement/negative acknowledgment (ACK/NACK) feedback) regarding whether a transmission was successfully received and decoded or not. For example, a UE may be scheduled by a network entity to receive a transmission on a channel (e.g., a downlink transmission on a physical downlink shared channel (PDSCH), as sidelink transmission, etc.) at a particular time. In certain aspects, the UE is scheduled by receiving, such as from the network entity, control information (e.g., downlink control information (DCI), sidelink control information, etc.) in a control channel (e.g., a physical downlink control channel (PDCCH), physical sidelink control channel (PSCCH), etc.) scheduling the transmission. The UE may be configured to transmit, such as to the network entity, feedback regarding whether the transmission was successfully received and decoded or not. For example, the UE may be configured to transmit an ACK when the transmission is successfully received and decoded, and not transmit any feedback when the transmission is not successfully received and decoded. As another example, the UE may be configured to transmit a NACK when the transmission is not successfully received and decoded, and not transmit any feedback when the transmission is successfully received and decoded. As yet another example, the UE may be configured to transmit an ACK when the transmission is successfully received and decoded, and transmit a NACK when the transmission is not successfully received and decoded.

In certain aspects, a UE may be scheduled to transmit feedback in a feedback occasion (e.g., a HARQ feedback occasion), which refers to one or more time-frequency resources configured for the UE to transmit feedback. In certain aspects, the UE may be configured or scheduled to transmit feedback in a channel used for other signaling, such as control information or data, such as in a physical uplink shared channel (PUSCH), a physical uplink control channel (PUCCH), a PSCCH, a physical sidelink shared channel (PSSCH), etc.

In certain aspects, a wireless communications device having intermittent availability to communicate may not be able to transmit feedback for a transmission for a period of time after receiving the transmission. Accordingly, certain aspects herein provide techniques for scheduling a wireless communications device to transmit feedback to accommodate for times when the wireless communications device is able to transmit feedback. Such aspects beneficially allow for more reliable communications, as devices are less likely to be scheduled to transmit feedback at times they are unable to, which ensures feedback is properly communicated. Proper communication of feedback can help with timely retransmissions of data, or prevent retransmissions of data, as appropriate, to the receiving device.

Certain aspects provide techniques for a UE to transmit (e.g., to a network entity) a recommended minimum offset time (e.g., K1_min), the minimum offset time being a minimum time between communication (e.g., transmission by the UE, reception by the network entity) of feedback for a data transmission and communication (e.g., reception by the UE, transmission by the network entity) of the data transmission. In certain aspects, the UE determines K1_min based on a charging capability of the UE, such that the UE expects to harvest sufficient power during K1_min to be able to transmit feedback. Beneficially, the UE may then not be scheduled to transmit feedback at a time less than K1_min after receiving a data transmission, thereby increasing the chance the UE is able to transmit feedback as scheduled.

Additionally or alternatively, certain aspects provide techniques for a UE to provide one or more minimum time gaps between one or more types of communications (e.g., between an uplink (UL) communication followed by a downlink (DL) communication, a DL communication followed by a DL communication, an UL communication followed by an UL communication, a DL communication followed by an UL communication, a sidelink (SL) communication followed by an SL communication, etc.). In certain aspects, such information may be used by a network entity to determine an offset time between transmission of feedback for a data transmission and reception of the data transmission by the UE, such as based on a minimum time gap between DL and UL communications. The UE may select the one or more minimum time gaps, such that the UE expects to harvest sufficient power between communications to perform the communications, thereby increasing the likelihood of successful communications.

Additionally or alternatively, certain aspects provide techniques for configuring (e.g., by a network entity) a UE with multiple feedback occasions to transmit feedback for a given transmission. Beneficially, if the UE is unable to communicate during one of the multiple feedback occasions, it can still provide feedback during another feedback occasion of the multiple feedback occasions, thus increasing the reliability of the UE providing feedback.

Additionally or alternatively, certain aspects provide techniques for configuring (e.g., by a network entity) a UE with a time window during which the UE can asynchronously transmit feedback, such as in a PUCCH resource, PUSCH resource, PSCCH resource, or PSSCH resource. Beneficially, if the UE is unable to communicate during a feedback occasion, it can still provide feedback in another suitable resource during the time window.

Additionally or alternatively, certain aspects provide techniques for a UE to indicate (e.g., to a network entity) whether it is able to receive a transmission and send feedback at a given time period. Beneficially, the UE may be scheduled (e.g., by the network entity) to receive a transmission and send feedback only when the UE is able to do so, thereby increasing the reliability of the UE providing feedback.

Additionally or alternatively, certain aspects provide techniques for a UE to transmit feedback for multiple transmissions during a single feedback occasion. Less power may be needed to transmit feedback for multiple transmissions during one feedback occasions, as opposed to in separate feedback occasions, thereby reducing power usage by the UE.

Additionally or alternatively, certain aspects provide techniques for a UE to indicate (e.g., to a network entity) whether it is able to continue uplink or downlink communications. Beneficially, the UE may then only be scheduled to communicate at suitable times, thereby increasing reliability of communications.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

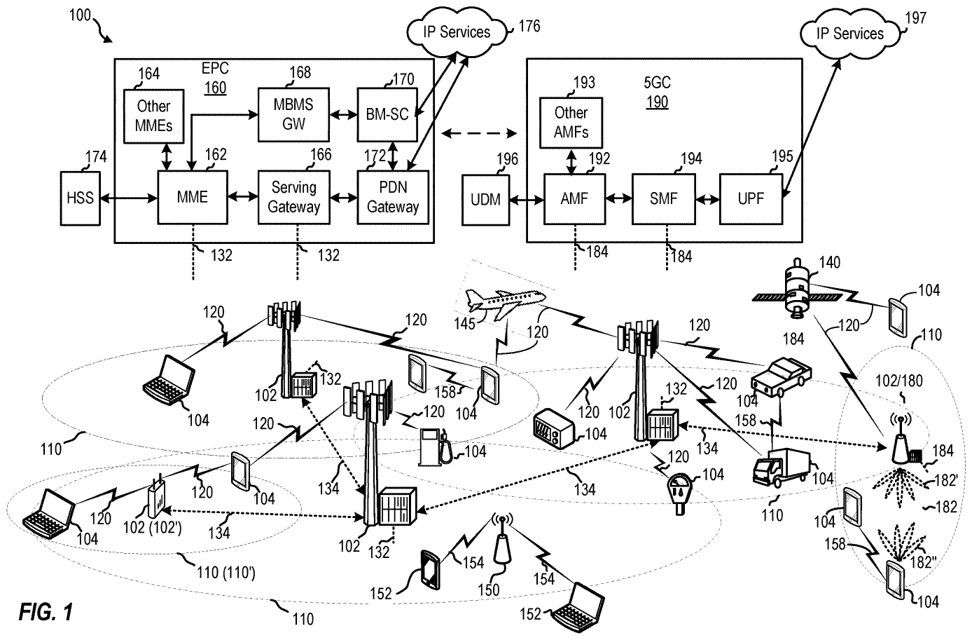

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

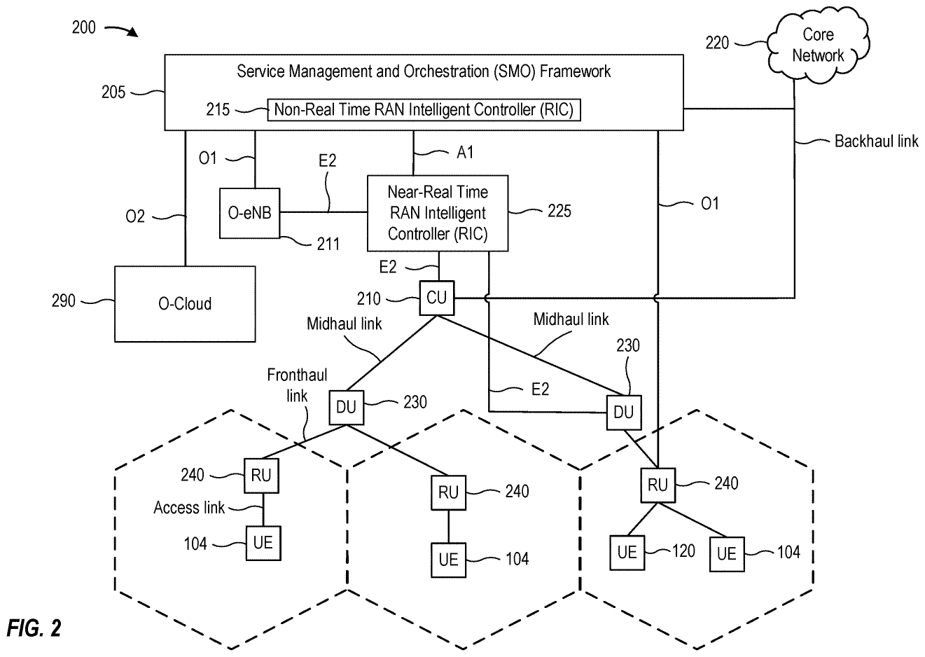

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5 GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1(FR1 ) as including 600 MHz-6 GHz, which is often referred to (interchangeably) as “Sub-6 GHz”. Similarly, 3GPP currently defines Frequency Range 2(FR2 ) as including 26-41 GHz, which is sometimes referred to (interchangeably) as a “millimeter wave” (“mmW” or “mmWave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5 GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an Ol interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

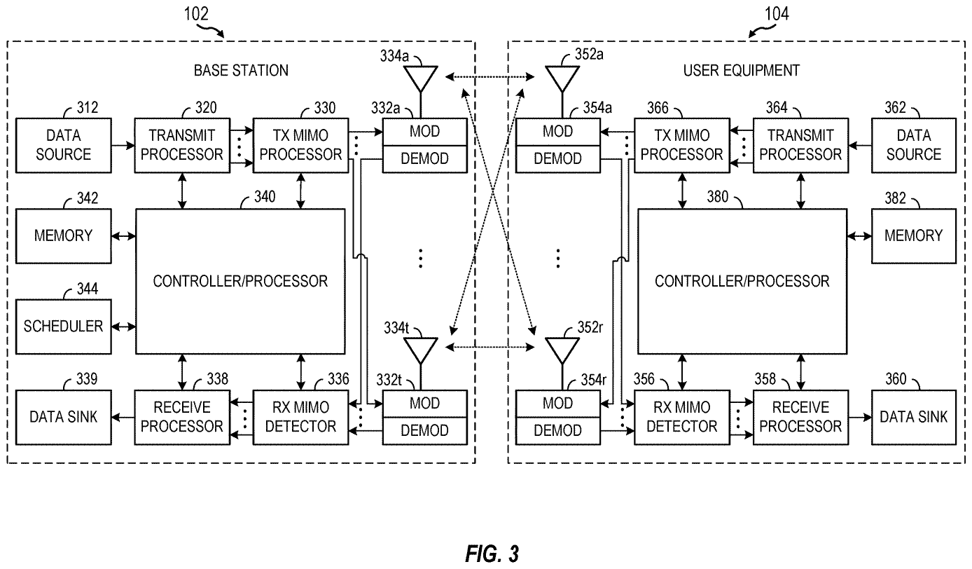

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332 a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354 a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

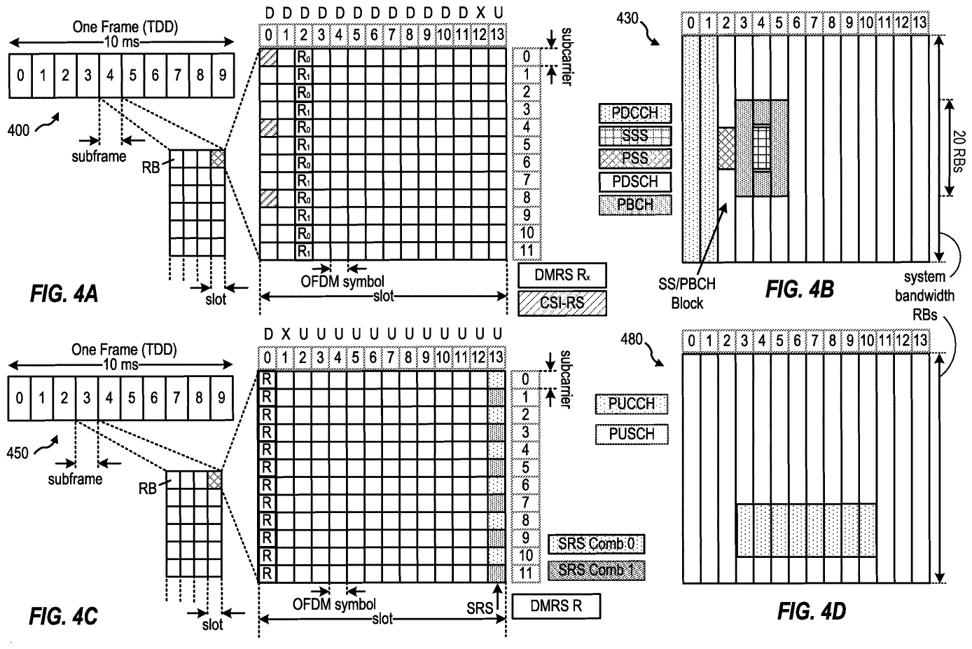

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Indication of a Recommended Minimum Offset Time

In certain aspects, a UE needs time to process a received transmission, such as on a PDSCH or PSSCH, before the UE is able to provide feedback regarding reception and decoding of the received transmission. In certain aspects, the time the UE needs to process the received transmission is referred to as N1. In certain aspects, the UE is configured, such as by a network entity, with a feedback occasion for a transmission, by a time offset relative to the end time of the transmission. The time offset may be referred to as K1. In certain aspects, K1>N1 so that the UE has sufficient time to process the transmission in order to provide feedback at time K1 after receiving the transmission.

As discussed, for certain UEs, such as an EH-UE, it may be desirable for K1 to be based on additional information, such as information as to when the UE may be able to transmit feedback after receiving a transmission, such as having sufficient time to perform energy harvesting. Accordingly, certain aspects provide techniques for a UE to indicate a recommended minimum time offset, which may be referred to as K1_min. In certain aspects, the network entity configures K1 to be greater than K1_min, for example K1≥K1_min≥N1.

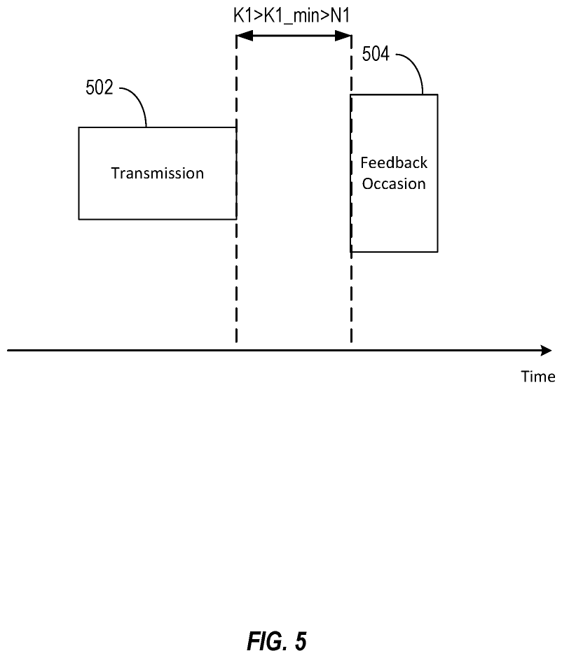

FIG. 5 depicts a time offset between a transmission and a feedback occasion. As shown, the feedback occasion 504 occurs the time K1 after the transmission 502, and K1≥K1_min≥N1.

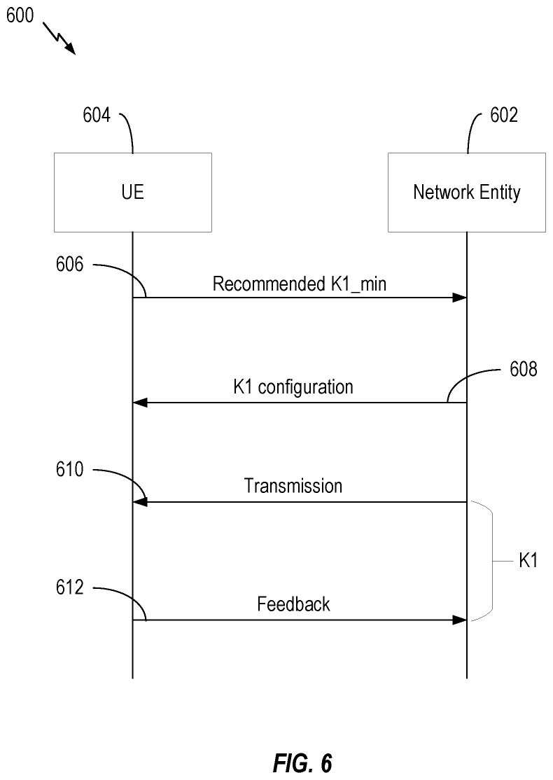

FIG. 6 depicts a process flow 600 for communications in a network between a network entity 602 and a user equipment (UE) 604. In some aspects, the network entity 602 may be an example of the BS 102, UE 104, or a component of BS 102 depicted and described with respect to FIGS. 1 and 3. Similarly, the UE 604 may be an example of UE 104 depicted and described with respect to FIGS. 1 and 3. However, in other aspects, UE 604 may be another type of wireless communications device and network entity 602 may be another type of network entity or network node, such as those described herein.

At 606, UE 604 sends, to network entity 602, an indication of a recommended minimum offset time (e.g., K1_min), the recommended minimum offset time being a minimum time between transmission of feedback for a data transmission and reception of the data transmission. In certain aspects, the recommended minimum offset time can be referred to as a minimum time between communication of feedback for a data transmission and communication of the data transmission, as from the perspective of UE 604, the data transmission may be received and the feedback may be transmitted, while from the perspective of network entity 602, the data transmission may be transmitted and the feedback may be received.

In certain aspects, UE 604 sends the indication using one of L3 signaling (e.g., a radio resource control (RRC) message), L2 signaling (e.g., a medium access control (MAC) control element (CE)), or L1 signaling (e.g., an uplink control information (UCI) or a sidelink control information (SCI)). In certain aspects, the recommended minimum offset time is a first recommendation sent by UE 604 to network entity 602 for communications between UE 604 and network entity 602. In certain aspects, the recommended minimum offset time is an updated recommended minimum offset time. For example, UE 604 may determine that conditions have changed (e.g., energy harvesting is likely to take more/less time) and therefore update the recommended minimum offset time. In certain aspects, the indication includes an absolute value of the recommended minimum offset time. In certain aspects, the indication includes a delta value (a difference) from another value, such as a previous recommended minimum offset time, an N1 value, etc. The indication may include an actual value, or an index/code number that maps to a value (e.g., absolute or delta). In certain aspects, any reference herein to sending an indication of a value could be through sending the actual value (e.g., as an absolute value or a delta value) or an index/code number that maps to a value (e.g., as an absolute value or a delta value).

At 608, network entity 602 configures UE 604 with one or more values configuring timing for transmission of feedback for a data transmission. In certain aspects, the timing for transmission may also be referred to as a timing for communication, as from the perspective of UE 604, the feedback may be transmitted, while from the perspective of network entity 602, the feedback may be received. For example, network entity 602 configures UE 604 with the value K1, wherein K1≥K1_min. For example, UE 604 receives one or more messages, such as from network entity 602, indicating a first offset time (e.g., K1) that is greater than the recommended minimum offset time (e.g., K1_min).

At 610, UE 604 attempts to receive a transmission (e.g., as scheduled previously by network entity 602, such as by a configured grant, a dynamic grant, semi-periodic scheduling (SPS), etc.). At 612, UE 604 sends, to network entity 602, feedback for the transmission based on the timing for transmission of feedback (e.g., K1). For example, at time K1 after the scheduled transmission, UE 604 may transmit feedback for the transmission to network entity 602. In certain aspects, UE 604 is not configured or scheduled (e.g., by an uplink grant, downlink grant, and/or sideline grant, by network entity 602) for communication between the time period between 610 and 612.

### Aspects Related to Indication of a Minimum Time Gap

In certain aspects, such as additionally or alternatively to a UE indicating a recommended minimum offset time, a UE can dynamically indicate one or more minimum time gaps between communication occasions (e.g., between the end of one communication occasion and the start of a subsequent communication occasion, such as with no communication occasions in between). In certain aspects, the one or more minimum time gaps include a minimum time gap between the UE transmitting on a UL at a first uplink occasion and receiving on a DL at a first downlink occasion. In certain aspects, the one or more minimum time gaps include a minimum time gap between the UE transmitting on a UL at a first uplink occasion and transmitting on a UL at a second uplink occasion. In certain aspects, the one or more minimum time gaps include a minimum time gap between the UE receiving on a DL at a first downlink occasion and receiving on a DL at a second downlink occasion. In certain aspects, the one or more minimum time gaps include a minimum time gap between the UE receiving on a DL at a first downlink occasion and transmitting on a UL at a first uplink occasion. In certain aspects, the one or more minimum time gaps include a minimum time gap between the UE receiving/transmitting on a sidelink at a first sidelink occasion and receiving/transmitting on a sidelink at a second sidelink occasion.

For example, UE 604 may communicate to network entity 602, at 606, one or more minimum time gaps. The UE 604 may transmit an indication of the one or more minimum time gaps in a same message as a recommended minimum offset time, or in a separate message. The UE 604 may send, to network entity 602, an indication of the one or more minimum time gaps in one or more messages (e.g., in dedicated resources for such messaging), which may be one or more L1, L2, and/or L3 messages. In certain aspects, UE 604 selects the one or more minimum time gaps to give the UE 604 time to accumulate power between the communication occasions to perform the communications. In certain aspects, the time to accumulate power may be different between different types of communication occasions. In certain aspects, the UE 604 may update the one or more minimum time gaps, such as based on changed conditions. In certain aspects, the one or more minimum time gaps are a function of the type of channel/transmission on the communication occasion, such as one or more of sounding reference signal (SRS), channel state information reference signal (CSI-RS), PDSCH, PUSCH, PUCCH, and/or PSSCH.

In certain aspects, network entity 602 may schedule communications for UE 604 that abide by the one or more minimum time gaps. For example, based on the one or more minimum time gaps, the network entity 602 may configure one or more of a configured grant periodicity, a SPS periodicity, a time (e.g., K1) between a transmission (e.g., PDSCH) and feedback (e.g., HARQ-ACK) for the transmission, a time between an uplink transmission (e.g., PUSCH) and a next dynamic grant, and/or a time between an SPS and a dynamic grant or an uplink configured grant.

### Aspects Related to Indication of Multiple Feedback Occasions for a Single Transmission

In certain aspects, a UE is configured with multiple feedback occasions in which to be able to transmit feedback for a single transmission. For example, in certain aspects, network entity 602 configures UE 604 (e.g., at 608) with one or more values configuring timing for communication of feedback for a data transmission, and the one or more values configure multiple feedback occasions. For example, network entity 602 sends one or more messages to UE 604 indicating the one or more values. UE 604 may transmit feedback for the transmission in any of the multiple feedback occasions. For example, UE 604 may transmit feedback in a first occasion in time of the multiple feedback occasions at which UE 604 has accumulated enough power to transmit the feedback.

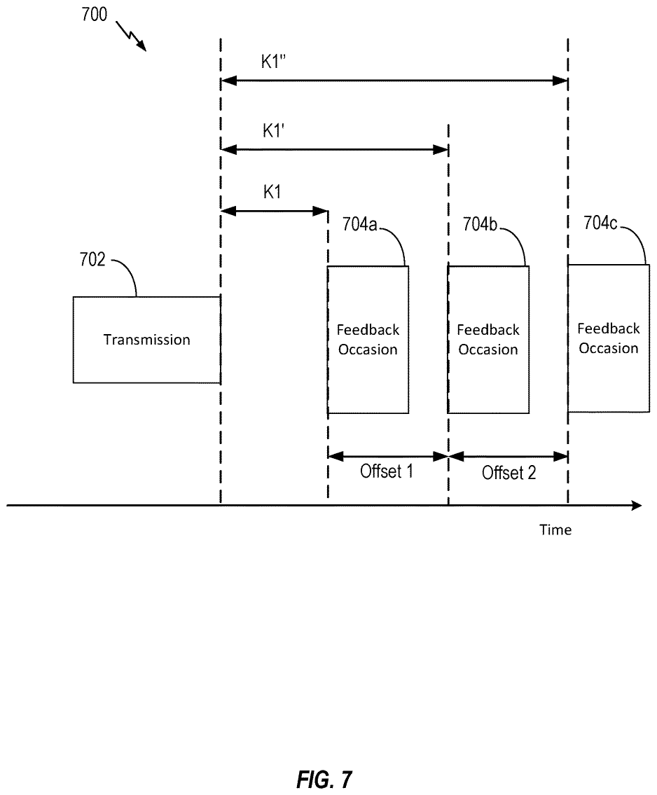

FIG. 7 depicts a timeline 700 for multiple configured feedback occasions for a scheduled transmission. As shown, multiple feedback occasions 704a-c are configured for a scheduled transmission 702. It should be noted that though three feedback occasions 704a-c are shown, there may be fewer or greater number of feedback occasions for a given transmission.

In certain aspects, the one or more values indicated in the one or more messages comprise a separate offset time between each of the plurality of feedback occasions 704a-c and scheduling of the data transmission 702. For example, in certain aspects, the one or more values indicate a first offset time (e.g., K1) between data transmission 702 and feedback occasion 704a, a second offset time (e.g., K1′) between data transmission 702 and feedback occasion 704b, and a third offset time (e.g., K1″) between data transmission 702 and feedback occasion 704c.

In certain aspects, the one or more values indicated in the one or more messages comprise an offset time between the first feedback occasion 704a and data transmission 702, and offset values between each of the feedback occasions. For example, in certain aspects, the one or more values indicate a first offset time (e.g., K1) between data transmission 702 and feedback occasion 704a, a second offset time (e.g., offset 1) between feedback occasion 704 a and feedback occasion 704b, and a third offset time (e.g., offset 2) between feedback occasion 704b and feedback occasion 704c.

In certain aspects, the one or more values indicated in the one or more messages comprise a periodicity of the plurality of feedback occasions. For example, in certain aspects, the one or more values indicate a first offset time (e.g., K1) between data transmission 702 and feedback occasion 704a, and a periodicity at which additional feedback occasions (e.g., feedback occasions 704b and 704c) occur after feedback occasion 704a. For example, if the periodicity is 5 ms, then feedback occasions occur every 5 ms after feedback occasions 704a. In certain aspects, feedback occasions may occur indefinitely, such as until UE 604 is able to transmit feedback. In certain aspects, the one or more value further comprise a number of the plurality of feedback occasions, such that the feedback occasions occur according to the periodicity until the number of the plurality of feedback occasions. For example, where the number of the plurality of feedback occasions is three, no additional feedback occasions are scheduled for transmission 702 other than feedback occasions 704a-704c.

In certain aspects, the one or more values indicated in the one or more messages comprise an offset time between the first feedback occasion 704a and data transmission 702. In certain such aspects, offset values between each of the feedback occasions, periodicity between feedback occasions, and/or number of feedback occasions are based on a capability or classification of the UE 604. For example, different classes of UEs, e. g, different EH-UEs with different energy harvesting capabilities, may have different configurations of (e.g., predetermined) offset values. In some aspects, UE 604 signals to network entity 602 its classification for scheduling.

In certain aspects, the one or more messages indicating the one or more values comprise one or more of a L3 message (e.g., RRC message), a L2 message (e.g., a MAC-CE), or a L1 message (e.g., a downlink control information (DCI)). For example, the one or more values may be indicated in a single L3, L2, or L1 message, or may be indicated in any combination of L1, L2, and/or L3 messages.

In one example, an L1 message (e.g., DCI, such as dynamic grant DCI or SPS activating DCI) includes a first offset time (e.g., K1) between data transmission 702 and feedback occasion 704a, while a second one or more messages (e.g., L1, L2, and/or L3 messages) include offset values between each of the feedback occasions, periodicity between feedback occasions, and/or number of feedback occasions. In certain aspects, the second one or more messages are communicated before the L1 message.

### Aspects Related to Asynchronous Feedback

In certain aspects, a UE is configured with a time window during which the UE can asynchronously transmit feedback, such as in a PUCCH resource, PUSCH resource, PSCCH resource, or PSSCH resource. For example, in certain aspects, network entity 602 configures UE 604 (e.g., at 608) with one or more values indicating the time window. For example, network entity 602 sends one or more messages to UE 604 indicating the one or more values. UE 604 may transmit feedback for the transmission in a resource (e.g., a resource not dedicated to feedback transmission) that occurs during the time window (e.g., uplink or sideline resource, such as a PUCCH resource, PUSCH resource, PSCCH resource, or PSSCH resource), and in which there is available space to transmit the feedback. For example, UE 604 may transmit feedback in a first uplink or sidelink resource in time, during the time window, at which UE 604 has accumulated enough power to transmit the feedback and there is space in the resource (e.g., available time-frequency resources) to transmit the feedback. In certain aspects, in the message including the feedback, UE 604 includes an identifier (e.g., HARQ-ACK ID) associated with the transmission for which the feedback is provided. For example, UE 604 may be scheduled with reception of multiple transmissions (e.g., PDSCH signals) during the time window and include the identifier to differentiate between them.

In certain aspects, the UE 604 may transmit the feedback in a resource not dedicated to feedback transmission when it is unable to transmit the feedback in a feedback occasion dedicated to feedback transmission, such as due to lack of energy, or collision with downlink symbols such as in SPS. For example, in certain aspects, the time window begins after the feedback occasion in which the UE 604 is unable to transmit the feedback.

In certain aspects, a start of the time window is defined as equal to or relative to (e.g., offset from) one of scheduled communication of a transmission for which feedback is being provided, start time of the transmission, end time of the transmission, start time of a message (e.g., DCI) scheduling the transmission, or end time of the message scheduling the transmission.

In certain aspects, the one or more values indicated in the one or more messages comprise a non-numerical value or a negative value indicating the time window. For example, the one or more values may include a non-numerical or a negative value for K1, that instead of defining the offset time between a transmission and a feedback occasion, indicate to the UE 604 to asynchronously transmit feedback during a time window.

In certain aspects, the one or more values indicated in the one or more messages comprise an offset time (e.g., K1) between the first feedback occasion in time (e.g., 704a) and data transmission (e.g., 702), e.g., after which UE 604 uses asynchronous feedback transmission during the time window. For example, UE 604 receives a separate message (e.g., one of an L1, L2, or L3 message) that activates use of the time window for asynchronous feedback transmission, such as from network entity 602.

In certain aspects, the start of the time window is configured by network entity 602, such as using one of an L1, L2, or L3 message sent to UE 604 (e.g., the same or different message activating the time window). In certain aspects, the start of the time window is pre-defined. In certain aspects, the start of the time window is based on a mapping of the non-numerical or negative value to a start time, wherein the mapping may be pre-defined or configured at UE 604 by network entity 602, such as using one of an L1, L2, or L3 message sent to UE 604. In certain aspects, a duration of the time window is indefinite, such as lasting until UE 604 is able to transmit feedback. In certain aspects, the duration of the time window is configured by network entity 602, such as using one of an L1, L2, or L3 message sent to UE 604 (e.g., the same or different message activating the time window). For example, the message may indicate an end time of the time window defining the duration along of the time window along with the start time. In another example, the message may indicate an actual time duration (e.g., in ms) or a number of scheduled transmissions (e.g., downlink transmissions) such that when UE 604 reaches the number of scheduled transmissions since the start time, the time window ends. In another example, the message may be sent at the end time, thereby ending the time window. In certain aspects, the duration of the time window is pre-defined. In certain aspects, the duration of the time window is based on a mapping of the non-numerical or negative value to a duration, wherein the mapping may be pre-defined or configured at UE 604 by network entity 602, such as using one of an L1, L2, or L3 message sent to UE 604.

### Aspects Related to Grant Assignment

In certain aspects, network entity 602 assigns grants (e.g., UL/DL/SL grants, including dynamic grants or configured grants) scheduling transmissions and/or configures a time offset value (e.g., K1) based on information from UE 604 indicating that it will be able to (e.g., has accumulated energy to) decode the transmission scheduled by the grant and transmit feedback for the transmission. In certain such aspects, UE 604 is configured to send, such as to network entity 602, an indication of whether the UE is capable of both decoding the transmission and transmitting the feedback. In certain aspects, the UE 604 predicts whether it will be capable of both decoding the transmission and transmitting the feedback at a particular time based on modeling the amount of predicted energy at the UE, such as using a predictive model (e.g., a machine learning model). In certain aspects, UE 604 based on information at UE 604, sends a message to network entity 602 indicating whether it can 1) decode the transmission (e.g., indicated by a first bit); and/or 2) transmit feedback (e.g., indicated by a second bit).

In certain aspects, UE 604 sends information to network entity 602 indicating one or more of a charging rate or configured parameters that indicate an amount of energy at a given time period, and the network entity 602 can determine when UE 604 will be capable of both decoding the transmission and transmitting the feedback at a particular time.

In certain aspects, network entity 602 assigns a grant and/or feedback occasion at a time when it is determined UE 604 will be capable of both decoding the transmission and transmitting the feedback at a particular time.

In certain aspects, UE 604 sends information to network entity 602 indicating a number of data transmissions (e.g., PDSCH transmissions) the UE is capable of decoding and a number of feedbacks the UE is capable of transmitting during a time window. In certain aspects, UE 604 sends information to network entity 602 indicating a size of data transmissions (e.g., PDSCH transmissions) the UE is capable of decoding and/or a size of uplink transmission (e.g., PUCCH and/or feedback) the UE is capable of transmitting during a time window. In certain aspects, network entity 602 assigns grants and/or feedback occasions up to the number/size of data transmissions and the number/size of uplink transmissions during the time window.

### Aspects Related to Bundled Feedback

In certain aspects, UE 604 is configured to send feedback for multiple scheduled communications in a single feedback occasion. In certain such aspects, UE 604 is configured with periodically occurring feedback occasions. For example, in certain aspects, network entity 602 configures UE 604 (e.g., at 608) with one or more values configuring timing for transmission of feedback for a data transmission, and the one or more values configure multiple feedback occasions. For example, network entity 602 sends one or more messages (e.g., L1, L2, and/or L3) to UE 604 indicating the one or more values.

In certain aspects, the one or more values indicated in the one or more messages comprise a periodicity of the plurality of feedback occasions. In certain aspects, feedback occasions may occur indefinitely, such as until a message (e.g., L1, L2, and/or L3) disabling or updating the periodic feedback occasions is received from network entity 602. In certain aspects, a periodicity of the feedback occasions may be updated via a message from network entity 602 sent to UE 604.

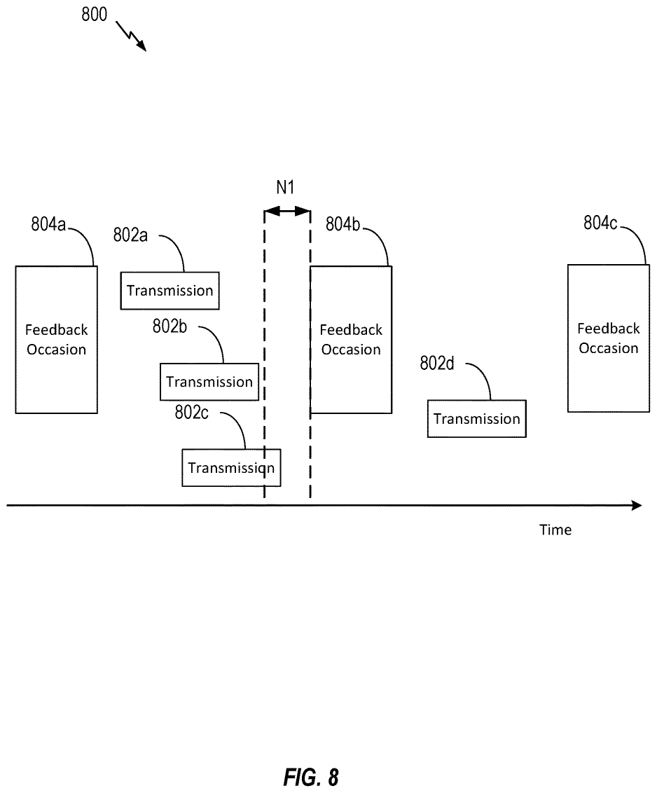

FIG. 8 depicts a timeline 800 including periodic feedback occasions for bundling feedback. As shown, multiple periodic feedback occasions 804a-c are configured. It should be noted that though three feedback occasions 804a-c are shown, there may be fewer or greater number of feedback occasions for a given transmission.

Further, as shown, four transmissions 802a-d are scheduled for UE 604 to receive. It should be noted that though four transmissions 802a-d are shown, there may be fewer or greater number of scheduled transmissions. The transmissions 802a-d may be scheduled by one or more grants sent from network entity 602 to UE 604, such as SPS only, or both SPS and dynamic grant.

In certain aspects, UE 604 is configured to transmit feedback for as many transmissions as it is able to in a given feedback occasion. For example, UE 604 may transmit feedback in feedback occasion 804b for any transmissions that meet time criteria N1, such as transmissions 802a and 802b, but not transmission 802c. In certain aspects, UE 604 may have an upper limit on the amount of feedback it can transmit in a single feedback occasion 804, and may therefore not include feedback for one or more transmissions that meet time criteria N1, and instead include the feedback in another feedback occasion. For example, UE 604 may transmit feedback in feedback occasion 804b for some transmissions that meet time criteria N1, such as transmissions 802a and 802b, but not other transmissions (not shown) that meet time criteria N1, and instead transmit feedback for such other transmissions in feedback occasion 804b, or not at all.

In certain aspects, UE 604 sends feedback in a given feedback occasion if there are at least a threshold number of transmissions (e.g., PDSCH occasions, such as having a HARQ-ACK transmission) for which the UE 604 has feedback to transmit (e.g., that meets the N1 time criteria). For example, assuming the threshold is three or four transmissions, UE 604 may not transmit feedback for transmissions 802a and 802b in feedback occasion 804b, as the feedback for two transmissions does not meet the threshold. However, UE 604 may transmit feedback for transmissions 802a-d in feedback occasion 804c, as the feedback for four transmissions does meet the threshold.

In certain aspects, UE 604 sends feedback in a given feedback occasion even if there are not at least a threshold number of transmissions, such as if a maximum time limit from receiving at least one of a plurality of data transmissions has been reached. For example, assume the threshold is five transmissions, and feedback for transmissions 802a-802d is not transmitted prior to feedback occasion 804c. In certain aspects, a maximum time between the accumulated data transmissions 802a-802d (e.g., from a start time or end time of a first data transmission in time 802a or from a start time or end time of a last data transmission in time 802d) to feedback occasion 804c may be reached, and therefore, feedback for transmissions 802a-802d may be transmitted in feedback occasion 804c.

### Aspects Related to Additional Feedback

In certain aspects, when transmitting feedback (e.g., at 612), UE 604 also indicates to network entity 602 a time duration it is able to stay active to receive data (e.g., referred to as time to dormant (TTD)), such as having enough energy to stay active. In certain aspects, the TTD is indicated in the same message as the feedback. In certain aspects, the TTD is indicated in a separate message (e.g., sent close in time to the feedback). In certain aspects, the TTD is indicated as an index value that maps to a TTD selected among a set of preconfigured values.

In certain aspects, when transmitting feedback (e.g., at 612), UE 604 also indicates to network entity 602 a single bit indicating that the UE 604 is capable of continuing to communicate (e.g., a “keep serving me” message) with network entity 602 or is not capable of continuing to communicate (e.g., a “stop serving me” message) with network entity 602. In certain aspects, the single bit is indicated in the same message as the feedback. In certain aspects, the single bit is indicated in a separate message (e.g., sent close in time to the feedback). In certain aspects, based on the single bit indicating that UE 604 is not capable of continuing to communicate with network entity 602, network entity 602 terminates configuring uplink grants for UE 604, such as uplink configured grants or SPS.

In certain aspects, when transmitting feedback (e.g., at 612), UE 604 also indicates to network entity 602 one or more bits indicating that the UE 604 is capable of continuing to communicate (e.g., a “keep serving me” message) with network entity 602 or is not capable of continuing to communicate (e.g., a “stop serving me” message) with network entity 602 for each of certain types of communications (e.g., UL and/or DL) and/or for a certain time duration (e.g., number of slots, until the end of a discontinuous reception (DRX) on duration, for a number of DRX on durations, etc.). For example, in certain aspects the one or more bits indicate to continue or terminate DL communication for X slots or DRX on durations. In certain aspects the one or more bits indicate to continue or terminate UL communication for Y slots or DRX on durations. In certain aspects the one or more bits indicate to continue or terminate DL and UL communication for Z slots or DRX on durations. In certain aspects, X, Y, Z, and/or the number of DRX on durations may be configured (e.g., preconfigured) and selected from a set of such configured values, such as based in part on power modeling for decoding/encoding of each physical channel and/or charging rate of the UE (e.g., which may change at different times).

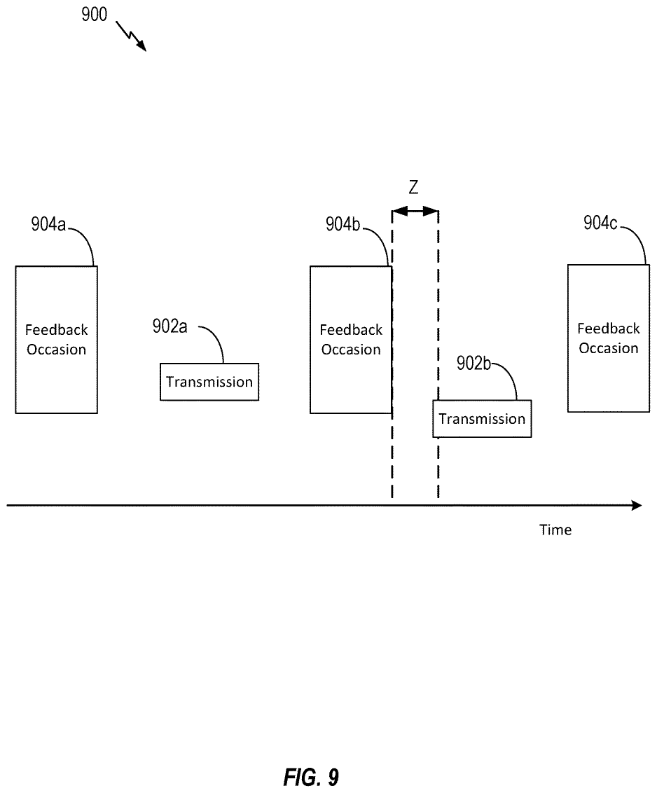

In certain aspects, UE 604 is configured to multiplex feedback, TTD, the one or more bits, and/or the single-bit with a non-feedback dedicated resource (e.g., a PUCCH transmission, a PUSCH transmission, a PSCCH transmission, or a PSSCH transmission) if UE 604 is not able to (e.g., does not have energy) to send the feedback for a transmission in a feedback occasion, and a time difference between the (e.g., end of the) feedback occasion and the (e.g., start of the) non-feedback dedicated resource is less than a threshold (e.g., Z) and the non-feedback dedicated resource occurs before another feedback occasion for the transmission. For example, FIG. 9 depicts an example feedback timeline 900. Multiple feedback occasions 904a-904c are shown. Further, a downlink transmission occasion 902a for scheduled reception by UE 604 is shown, as well as an uplink transmission occasion 902b for scheduled transmission by UE 604 is shown. In certain aspects, UE 604 may not have energy to transmit feedback for downlink transmission occasion 902a at feedback occasion 904b. Further, uplink transmission occasion 902b occurs within the threshold Z of feedback occasion 904b and before feedback occasion 904c. Accordingly, UE 604 may transmit feedback for downlink transmission occasion 902a in uplink transmission occasion 902b.

### Example Operations of a User Equipment

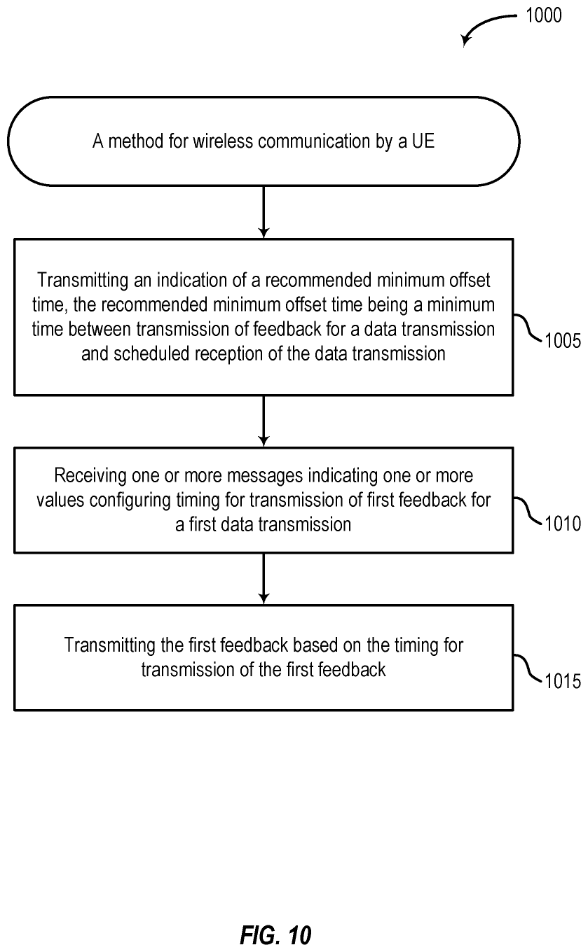

FIG. 10 shows a method 1000 for wireless communications by a UE, such as UE 104 of FIGS. 1 and 3.

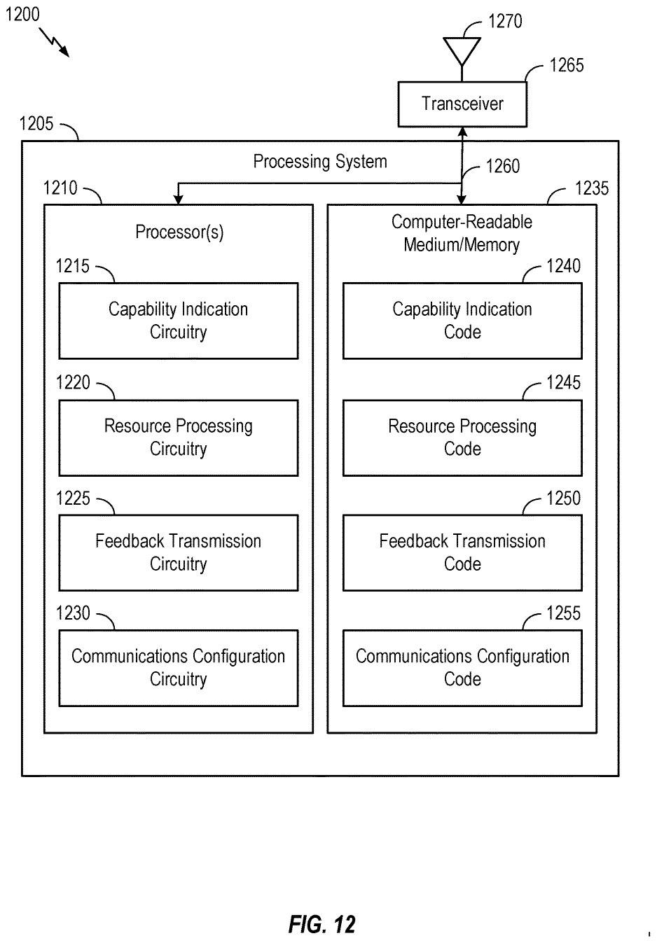

Method 1000 begins at 1005 with transmitting an indication of a recommended minimum offset time, the recommended minimum offset time being a minimum time between transmission of feedback for a data transmission and scheduled reception of the data transmission. In some cases, the operations of this step refer to, or may be performed by, capability indication circuitry as described with reference to FIG. 12.

Method 1000 then proceeds to step 1010 with receiving one or more messages indicating one or more values configuring timing for transmission of first feedback for a first data transmission. In some cases, the operations of this step refer to, or may be performed by, resource processing circuitry as described with reference to FIG. 12.

Method 1000 then proceeds to step 1015 with transmitting the first feedback based on the timing for transmission of the first feedback. In some cases, the operations of this step refer to, or may be performed by, feedback transmission circuitry as described with reference to FIG. 12.

Various aspects relate to the method 1000, including the following aspects.

In some aspects, the one or more values comprise a first offset time between a first feedback occasion for transmission of the first feedback and scheduled reception of the first data transmission, wherein the first offset time is greater than or equal to the recommended minimum offset time.

In some aspects, the timing for transmission of the first feedback for the first data transmission comprises timing of a plurality of feedback occasions for transmitting the first feedback.

In some aspects, the one or more values comprise a separate offset time between each of the plurality of feedback occasions and scheduled reception of the first data transmission.

In some aspects, the one or more values comprise: a first offset time between a first feedback occasion for transmission of the first feedback and scheduled reception of the first data transmission; and a second offset time between a second feedback occasion of the plurality of feedback occasions and the first feedback occasion.

In some aspects, the one or more values comprise a periodicity of the plurality of feedback occasions.

In some aspects, the one or more values comprise a number of the plurality of feedback occasions.

In some aspects, the one or more values comprise a first offset time between a first feedback occasion for transmission of the first feedback and scheduled reception of the first data transmission, and wherein the first offset time and a classification of the UE configure the timing of the plurality of feedback occasions.

In some aspects, the one or more messages comprise one or more of a RRC message, a MAC-CE, or a DCI.

In some aspects, method 1000 further includes receiving at least one uplink grant for one or more uplink resources not dedicated for feedback transmission, wherein the timing for transmission of the first feedback for the first data transmission comprises a time window, and wherein transmitting the first feedback based on the timing comprises transmitting the first feedback in a first uplink resource, of the one or more uplink resources, that occurs during the time window.

In some aspects, the one or more values comprise a non-numerical value or a negative value indicating the time window.

In some aspects, a start time of the time window is defined relative to one of a start time of the first data transmission, an end time of the first data transmission, a start time of a DCI scheduling the first data transmission, or an end time of the DCI scheduling the first data transmission.

In some aspects, method 1000 further includes transmitting an identifier associated with the first data transmission with the first feedback.

In some aspects, the one or more values comprise a first offset time between a first feedback occasion for transmission of the first feedback and scheduled reception of the first data transmission, and wherein the time window starts after the first feedback occasion.

In some aspects, the one or more messages comprise a first message indicating the first offset time and a second message indicating use of the time window.

In some aspects, the one or more values indicate a start time of the time window and an end time of the time window.

In some aspects, the one or more values indicate a start time of the time window and a number of downlink data transmissions defining an end time of the time window.

In some aspects, method 1000 further includes transmitting an indication of a minimum timing gap between a first type of communication by the UE and a second type of communication by the UE, wherein the one or more values comprise a first offset time between a first feedback occasion for transmission of the first feedback and scheduled reception of the first data transmission, wherein the first offset time is based on the minimum timing gap and the recommended minimum offset time.

In some aspects, method 1000 further includes transmitting an indication of whether the UE is capable of both decoding the first data transmission and transmitting the first feedback.

In some aspects, method 1000 further includes transmitting an indication of a number of data transmissions the UE is capable of decoding and a number of feedbacks the UE is capable of transmitting during a time window.

In some aspects, transmitting the first feedback comprises transmitting feedback for a plurality of data transmissions during a first feedback occasion.

In some aspects, the one or more values comprise a periodicity of a plurality of feedback occasions including the first feedback occasion.

In some aspects, transmitting the feedback for the plurality of data transmissions is based on a number of the plurality of data transmissions being greater than a threshold.

In some aspects, transmitting the feedback for the plurality of data transmissions is based on a number of the plurality of data transmissions being less than a threshold and a maximum time limit from receiving at least one of the plurality of data transmissions having been reached.

In some aspects, method 1000 further includes transmitting an indication of a time duration for which the UE can remain active.

In some aspects, the indication of the time duration comprises an index value that maps to the time duration.

In some aspects, method 1000 further includes transmitting, to a network entity, a single bit indication indicating whether the network entity should continue serving the UE.

In some aspects, the single bit indication indicates to stop configuring uplink configured grants for the UE.

In some aspects, the timing for transmission of the first feedback for the first data transmission comprises timing of a plurality of feedback occasions for transmitting the first feedback, and wherein the first feedback is transmitted in a uplink shared channel that occurs in time within a threshold time period after a first feedback occasion and before a second feedback occasion.

In some aspects, method 1000 further includes transmitting one or more bits indicating at least one of: a number of time periods to continue or terminate downlink communication with the UE or a number of time periods to continue or terminate uplink communication with the UE.

In some aspects, the UE is not scheduled for uplink or downlink communications between scheduled reception of the first data transmission and scheduled transmission of the first feedback.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Operations of a Network Entity

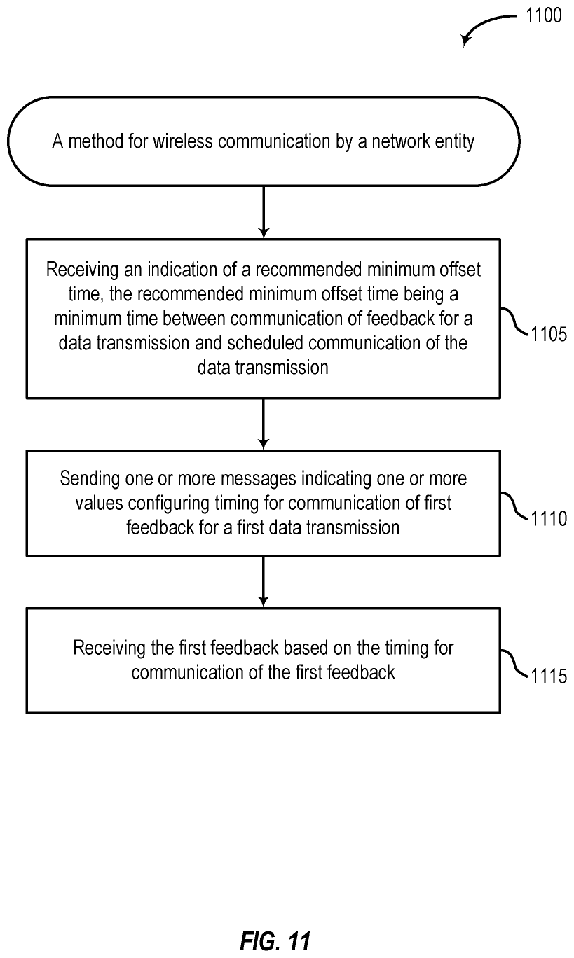

FIG. 11 shows a method 1100 for wireless communications by a network entity, such as BS 102 of FIGS. 1 and 3, or a disaggregated base station as discussed with respect to FIG. 2.

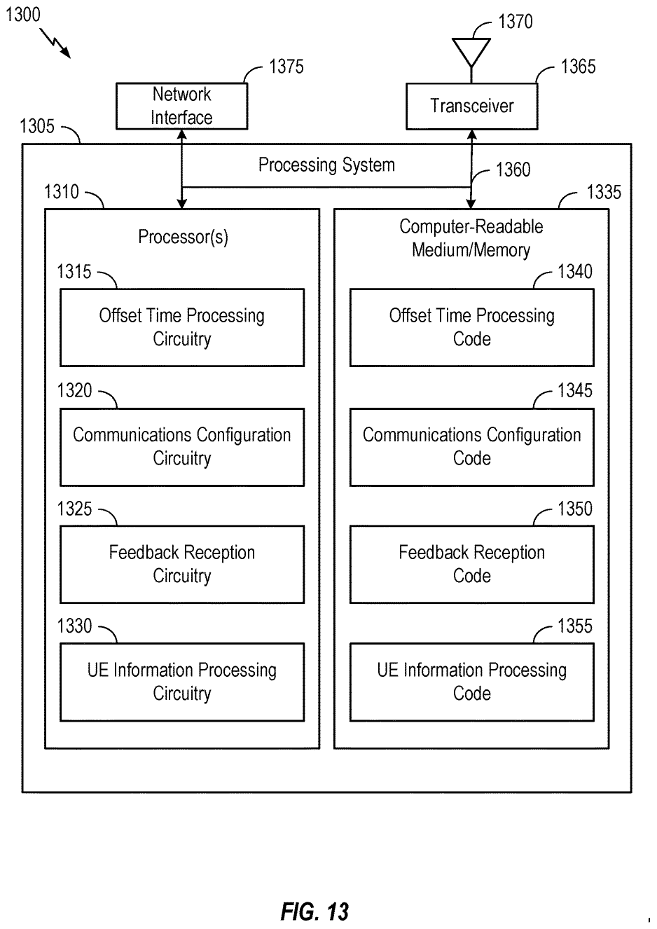

Method 1100 begins at 1105 with receiving an indication of a recommended minimum offset time, the recommended minimum offset time being a minimum time between communication of feedback for a data transmission and scheduled communication of the data transmission. In some cases, the operations of this step refer to, or may be performed by, offset time processing circuitry as described with reference to FIG. 13.

Method 1100 then proceeds to step 1110 with sending one or more messages indicating one or more values configuring timing for communication of first feedback for a first data transmission. In some cases, the operations of this step refer to, or may be performed by, communications configuration circuitry as described with reference to FIG. 13.

Method 1100 then proceeds to step 1115 with receiving the first feedback based on the timing for communication of the first feedback. In some cases, the operations of this step refer to, or may be performed by, feedback reception circuitry as described with reference to FIG. 13.

Various aspects relate to the method 1100, including the following aspects.

In some aspects, the one or more values comprise a first offset time between a first feedback occasion for communication of the first feedback and scheduled communication of the first data transmission, wherein the first offset time is greater than or equal to the recommended minimum offset time.

In some aspects, the timing for communication of the first feedback for the first data transmission comprises timing of a plurality of feedback occasions for communicating the first feedback.

In some aspects, the one or more values comprise a separate offset time between each of the plurality of feedback occasions and scheduled communication of the first data transmission.

In some aspects, the one or more values comprise: a first offset time between a first feedback occasion for communication of the first feedback and scheduled communication of the first data transmission; and a second offset time between a second feedback occasion of the plurality of feedback occasions and the first feedback occasion.

In some aspects, the one or more values comprise a periodicity of the plurality of feedback occasions.

In some aspects, the one or more values comprise a number of the plurality of feedback occasions.

In some aspects, the one or more values comprise a first offset time between a first feedback occasion for communication of the first feedback and scheduled communication of the first data transmission, and wherein the first offset time and a classification of a UE configure the timing of the plurality of feedback occasions.

In some aspects, the one or more messages comprise one or more of a RRC message, a MAC-CE, or a DCI.

Some examples of the method, apparatus, non-transitory computer readable medium, and system further include transmitting at least one uplink grant for one or more uplink resources not dedicated for feedback transmission, wherein the timing for communication of the first feedback for the first data transmission comprises a time window, and wherein receiving the first feedback based on the timing comprises receiving the first feedback in a first uplink resource, of the one or more uplink resources, that occurs during the time window.

In some aspects, the one or more values comprise a non-numerical value or a negative value indicating the time window.

In some aspects, a start time of the time window is defined relative to one of a start time of the first data transmission, an end time of the first data transmission, a start time of a DCI scheduling the first data transmission, or an end time of the DCI scheduling the first data transmission.

In some aspects, method 1100 further includes receiving an identifier associated with the first data transmission with the first feedback.

In some aspects, the one or more values comprise a first offset time between a first feedback occasion for communication of the first feedback and scheduled communication of the first data transmission, and wherein the time window starts after the first feedback occasion.

In some aspects, the one or more messages comprise a first message indicating the first offset time and a second message indicating use of the time window.

In some aspects, the one or more values indicate a start time of the time window and an end time of the time window.

In some aspects, the one or more values indicate a start time of the time window and a number of downlink data transmissions defining an end time of the time window.

In some aspects, method 1100 further includes receiving an indication of a minimum timing gap between a first type of communication by a UE and a second type of communication by the UE, wherein the one or more values comprise a first offset time between a first feedback occasion for communication of the first feedback and scheduled communication of the first data transmission, wherein the first offset time is based on the minimum timing gap and the recommended minimum offset time.

In some aspects, method 1100 further includes receiving an indication of whether a UE is capable of both decoding the first data transmission and transmitting the first feedback.

In some aspects, method 1100 further includes receiving an indication of a number of data transmissions a UE is capable of decoding and a number of feedbacks the UE is capable of transmitting during a time window.

In some aspects, receiving the first feedback comprises receiving feedback for a plurality of data transmissions during a first feedback occasion.

In some aspects, the one or more values comprise a periodicity of a plurality of feedback occasions including the first feedback occasion.

In some aspects, receiving the feedback for the plurality of data transmissions is based on a number of the plurality of data transmissions being greater than a threshold.

In some aspects, receiving the feedback for the plurality of data transmissions is based on a number of the plurality of data transmissions being less than a threshold and a maximum time limit from transmitting at least one of the plurality of data transmissions having been reached.

In some aspects, method 1100 further includes receiving an indication of a time duration for which a UE can remain active.

In some aspects, the indication of the time duration comprises an index value that maps to the time duration.

In some aspects, method 1100 further includes receiving a single bit indication indicating whether the network entity should continue serving a UE.

In some aspects, the single bit indication indicates to stop configuring uplink configured grants for the UE.

In some aspects, the timing for communication of the first feedback for the first data transmission comprises timing of a plurality of feedback occasions for communicating the first feedback, and wherein the first feedback is transmitted in a uplink shared channel that occurs in time within a threshold time period after a first feedback occasion and before a second feedback occasion.

In some aspects, method 1100 further includes receiving one or more bits indicating at least one of: a number of time periods to continue or terminate downlink communication with a UE or a number of time periods to continue or terminate uplink communication with the UE.

In some aspects, method 1100 further includes refraining from scheduling a UE for uplink or downlink communications between scheduled communication of the first data transmission and scheduled communication of the first feedback.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to the transceiver 1265 (e.g., a transmitter and/or a receiver). The transceiver 1265 is configured to transmit and receive signals for the communications device 1200 via the antenna 1270, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1235 via a bus 1260. In certain aspects, the computer-readable medium/memory 1235 is configured to store instructions (e.g., computer-executable code) that when executed by the one or more processors 1210, cause the one or more processors 1210 to perform the method 1000 described with respect to FIG. 10, or any aspect related to it. Note that reference to a processor performing a function of communications device 1200 may include one or more processors 1210 performing that function of communications device 1200.

In the depicted example, computer-readable medium/memory 1235 stores code (e.g., executable instructions), such as capability indication code 1240, resource processing code 1245, feedback transmission code 1250, and communications configuration code 1255. Processing of the capability indication code 1240, resource processing code 1245, feedback transmission code 1250, and communications configuration code 1255 may cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry such as capability indication circuitry 1215, resource processing circuitry 1220, feedback transmission circuitry 1225, and communications configuration circuitry 1230. Processing with capability indication circuitry 1215, resource processing circuitry 1220, feedback transmission circuitry 1225, and communications configuration circuitry 1230 may cause the communications device 1200 to perform the method 1000 described with respect to FIG. 10, or any aspect related to it.

Various components of the communications device 1200 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1265 and the antenna 1270 of the communications device 1200 in FIG. 12. Means for receiving or obtaining may include transceivers 354 and/or antenna(s) 352 of the UE 104 illustrated in FIG. 3 and/or the transceiver 1265 and the antenna 1270 of the communications device 1200 in FIG. 12.

According to some aspects, capability indication circuitry 1215 transmits an indication of a recommended minimum offset time, the recommended minimum offset time being a minimum time between transmission of feedback for a data transmission and scheduled reception of the data transmission. According to some aspects, resource processing circuitry 1220 receives one or more messages indicating one or more values configuring timing for transmission of first feedback for a first data transmission. According to some aspects, feedback transmission circuitry 1225 transmits the first feedback based on the timing for transmission of the first feedback.

In some aspects, the one or more values comprise a first offset time between a first feedback occasion for transmission of the first feedback and scheduled reception of the first data transmission, wherein the first offset time is greater than or equal to the recommended minimum offset time. In some aspects, the timing for transmission of the first feedback for the first data transmission comprises timing of a set of feedback occasions for transmitting the first feedback. In some aspects, the one or more values comprise a separate offset time between each of the set of feedback occasions and scheduled reception of the first data transmission. In some aspects, the one or more values comprise: a first offset time between a first feedback occasion for transmission of the first feedback and scheduled reception of the first data transmission; and a second offset time between a second feedback occasion of the set of feedback occasions and the first feedback occasion. In some aspects, the one or more values comprise a periodicity of the set of feedback occasions. In some aspects, the one or more values comprise a number of the set of feedback occasions. In some aspects, the one or more values comprise a first offset time between a first feedback occasion for transmission of the first feedback and scheduled reception of the first data transmission, and wherein the first offset time and a classification of the UE configure the timing of the set of feedback occasions. In some aspects, the one or more messages comprise one or more of a RRC message, a MAC-CE, or a DCI.

According to some aspects, communications configuration circuitry 1230 receives at least one uplink grant for one or more uplink resources not dedicated for feedback transmission, wherein the timing for transmission of the first feedback for the first data transmission comprises a time window, and wherein transmitting the first feedback based on the timing comprises transmitting the first feedback in a first uplink resource, of the one or more uplink resources, that occurs during the time window. In some aspects, the one or more values comprise a non-numerical value or a negative value indicating the time window. In some aspects, a start time of the time window is defined relative to one of a start time of the first data transmission, an end time of the first data transmission, a start time of a DCI scheduling the first data transmission, or an end time of the DCI scheduling the first data transmission.

In some examples, feedback transmission circuitry 1225 transmits an identifier associated with the first data transmission with the first feedback. In some aspects, the one or more values comprise a first offset time between a first feedback occasion for transmission of the first feedback and scheduled reception of the first data transmission, and wherein the time window starts after the first feedback occasion. In some aspects, the one or more messages comprise a first message indicating the first offset time and a second message indicating use of the time window. In some aspects, the one or more values indicate a start time of the time window and an end time of the time window. In some aspects, the one or more values indicate a start time of the time window and a number of downlink data transmissions defining an end time of the time window.

In some examples, capability indication circuitry 1215 transmits an indication of a minimum timing gap between a first type of communication by the UE and a second type of communication by the UE, wherein the one or more values comprise a first offset time between a first feedback occasion for transmission of the first feedback and scheduled reception of the first data transmission, wherein the first offset time is based on the minimum timing gap and the recommended minimum offset time. In some examples, capability indication circuitry 1215 transmits an indication of whether the UE is capable of both decoding the first data transmission and transmitting the first feedback. In some examples, capability indication circuitry 1215 transmits an indication of a number of data transmissions the UE is capable of decoding and a number of feedbacks the UE is capable of transmitting during a time window. In some aspects, transmitting the first feedback comprises transmitting feedback for a set of data transmissions during a first feedback occasion. In some aspects, the one or more values comprise a periodicity of a set of feedback occasions including the first feedback occasion. In some aspects, transmitting the feedback for the set of data transmissions is based on a number of the set of data transmissions being greater than a threshold. In some aspects, transmitting the feedback for the set of data transmissions is based on a number of the set of data transmissions being less than a threshold and a maximum time limit from receiving at least one of the set of data transmissions having been reached.

In some examples, communications configuration circuitry 1230 transmits an indication of a time duration for which the UE can remain active. In some aspects, the indication of the time duration comprises an index value that maps to the time duration. In some examples, communications configuration circuitry 1230 transmits, to a network entity, a single bit indication indicating whether the network entity should continue serving the UE. In some aspects, the single bit indication indicates to stop configuring uplink configured grants for the UE. In some aspects, the timing for transmission of the first feedback for the first data transmission comprises timing of a set of feedback occasions for transmitting the first feedback, and wherein the first feedback is transmitted in a uplink shared channel that occurs in time within a threshold time period after a first feedback occasion and before a second feedback occasion. In some examples, communications configuration circuitry 1230 transmits one or more bits indicating at least one of: a number of time periods to continue or terminate downlink communication with the UE or a number of time periods to continue or terminate uplink communication with the UE. In some aspects, the UE is not scheduled for uplink or downlink communications between scheduled reception of the first data transmission and scheduled transmission of the first feedback.

FIG. 13 depicts aspects of an example communications device 1300. In some aspects, communications device 1300 is a network entity, such as BS 102 described above with respect to FIGS. 1 and 3.

The communications device 1300 includes a processing system 1305 coupled to the transceiver 1365 (e.g., a transmitter and/or a receiver) and/or a network interface 1375. The transceiver 1365 is configured to transmit and receive signals for the communications device 1300 via the antenna 1370, such as the various signals as described herein. The network interface 1375 is configured to obtain and send signals for the communications device 1300 via communication link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, cause the one or more processors 1310 to perform the method 1100 described with respect to FIG. 11, or any aspect related to it. Note that reference to a processor of communications device 1300 performing a function may include one or more processors 1310 of communications device 1300 performing that function.

In the depicted example, the computer-readable medium/memory 1335 stores code (e.g., executable instructions), such as offset time processing code 1340, communications configuration code 1345, feedback reception code 1350, and UE information processing code 1355. Processing of the offset time processing code 1340, communications configuration code 1345, feedback reception code 1350, and UE information processing code 1355 may cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry such as offset time processing circuitry 1315, communications configuration circuitry 1320, feedback reception circuitry 1325, and UE information processing circuitry 1330. Processing with offset time processing circuitry 1315, communications configuration circuitry 1320, feedback reception circuitry 1325, and UE information processing circuitry 1330 may cause the communications device 1300 to perform the method 1100 as described with respect to FIG. 11, or any aspect related to it.

Various components of the communications device 1300 may provide means for performing the method 1100 as described with respect to FIG. 11, or any aspect related to it. Means for transmitting, sending or outputting for transmission may include transceivers 332 and/or antenna(s) 334 of the BS 102 illustrated in FIG. 3 and/or the transceiver 1365 and the antenna 1370 of the communications device 1300 in FIG. 13. Means for receiving or obtaining may include transceivers 332 and/or antenna(s) 334 of the BS 102 illustrated in FIG. 3 and/or the transceiver 1365 and the antenna 1370 of the communications device 1300 in FIG. 13.

According to some aspects, offset time processing circuitry 1315 receives an indication of a recommended minimum offset time, the recommended minimum offset time being a minimum time between communication of feedback for a data transmission and scheduled communication of the data transmission. According to some aspects, communications configuration circuitry 1320 sends one or more messages indicating one or more values configuring timing for communication of first feedback for a first data transmission. According to some aspects, feedback reception circuitry 1325 receives the first feedback based on the timing for communication of the first feedback.

In some aspects, the one or more values comprise a first offset time between a first feedback occasion for communication of the first feedback and scheduled communication of the first data transmission, wherein the first offset time is greater than or equal to the recommended minimum offset time. In some aspects, the timing for communication of the first feedback for the first data transmission comprises timing of a set of feedback occasions for communicating the first feedback. In some aspects, the one or more values comprise a separate offset time between each of the set of feedback occasions and scheduled communication of the first data transmission. In some aspects, the one or more values comprise: a first offset time between a first feedback occasion for communication of the first feedback and scheduled communication of the first data transmission; and a second offset time between a second feedback occasion of the set of feedback occasions and the first feedback occasion. In some aspects, the one or more values comprise a periodicity of the set of feedback occasions. In some aspects, the one or more values comprise a number of the set of feedback occasions. In some aspects, the one or more values comprise a first offset time between a first feedback occasion for communication of the first feedback and scheduled communication of the first data transmission, and wherein the first offset time and a classification of a UE configure the timing of the set of feedback occasions. In some aspects, the one or more messages comprise one or more of a RRC message, a MAC-CE, or a DCI.

In some examples, communications configuration circuitry 1320 transmits at least one uplink grant for one or more uplink resources not dedicated for feedback transmission, wherein the timing for communication of the first feedback for the first data transmission comprises a time window, and wherein receiving the first feedback based on the timing comprises receiving the first feedback in a first uplink resource, of the one or more uplink resources, that occurs during the time window. In some aspects, the one or more values comprise a non-numerical value or a negative value indicating the time window. In some aspects, a start time of the time window is defined relative to one of a start time of the first data transmission, an end time of the first data transmission, a start time of a DCI scheduling the first data transmission, or an end time of the DCI scheduling the first data transmission.

In some examples, feedback reception circuitry 1325 receives an identifier associated with the first data transmission with the first feedback. In some aspects, the one or more values comprise a first offset time between a first feedback occasion for communication of the first feedback and scheduled communication of the first data transmission, and wherein the time window starts after the first feedback occasion. In some aspects, the one or more messages comprise a first message indicating the first offset time and a second message indicating use of the time window. In some aspects, the one or more values indicate a start time of the time window and an end time of the time window. In some aspects, the one or more values indicate a start time of the time window and a number of downlink data transmissions defining an end time of the time window.

According to some aspects, UE information processing circuitry 1330 receives an indication of a minimum timing gap between a first type of communication by a UE and a second type of communication by the UE, wherein the one or more values comprise a first offset time between a first feedback occasion for communication of the first feedback and scheduled communication of the first data transmission, wherein the first offset time is based on the minimum timing gap and the recommended minimum offset time. In some examples, UE information processing circuitry 1330 receives an indication of whether a UE is capable of both decoding the first data transmission and transmitting the first feedback. In some examples, UE information processing circuitry 1330 receives an indication of a number of data transmissions a UE is capable of decoding and a number of feedbacks the UE is capable of transmitting during a time window. In some aspects, receiving the first feedback comprises receiving feedback for a set of data transmissions during a first feedback occasion. In some aspects, the one or more values comprise a periodicity of a set of feedback occasions including the first feedback occasion.

In some aspects, receiving the feedback for the set of data transmissions is based on a number of the set of data transmissions being greater than a threshold. In some aspects, receiving the feedback for the set of data transmissions is based on a number of the set of data transmissions being less than a threshold and a maximum time limit from transmitting at least one of the set of data transmissions having been reached. In some examples, UE information processing circuitry 1330 receives an indication of a time duration for which a UE can remain active. In some aspects, the indication of the time duration comprises an index value that maps to the time duration. In some examples, UE information processing circuitry 1330 receives a single bit indication indicating whether the network entity should continue serving a UE.

In some aspects, the single bit indication indicates to stop configuring uplink configured grants for the UE. In some aspects, the timing for communication of the first feedback for the first data transmission comprises timing of a set of feedback occasions for communicating the first feedback, and wherein the first feedback is transmitted in a uplink shared channel that occurs in time within a threshold time period after a first feedback occasion and before a second feedback occasion. In some examples, UE information processing circuitry 1330 receives one or more bits indicating at least one of: a number of time periods to continue or terminate downlink communication with a UE or a number of time periods to continue or terminate uplink communication with the UE.

In some examples, communications configuration circuitry 1320 refrains from scheduling a UE for uplink or downlink communications between scheduled communication of the first data transmission and scheduled communication of the first feedback.

### Example Clauses

Implementation examples are described in the following numbered clauses:
Clause 1: A method for wireless communications by a UE, comprising: transmitting an indication of a recommended minimum offset time, the recommended minimum offset time being a minimum time between transmission of feedback for a data transmission and scheduled reception of the data transmission; receiving one or more messages indicating one or more values configuring timing for transmission of first feedback for a first data transmission; and transmitting the first feedback based on the timing for transmission of the first feedback.
Clause 2: The method of Clause 1, wherein the one or more values comprise a first offset time between a first feedback occasion for transmission of the first feedback and scheduled reception of the first data transmission, wherein the first offset time is greater than or equal to the recommended minimum offset time.
Clause 3: The method of any one of Clauses 1 and 2, wherein the timing for transmission of the first feedback for the first data transmission comprises timing of a plurality of feedback occasions for transmitting the first feedback.
Clause 4: The method of Clause 3, wherein the one or more values comprise a separate offset time between each of the plurality of feedback occasions and scheduled reception of the first data transmission.
Clause 5: The method of Clause 3, wherein the one or more values comprise: a first offset time between a first feedback occasion for transmission of the first feedback and scheduled reception of the first data transmission; and a second offset time between a second feedback occasion of the plurality of feedback occasions and the first feedback occasion.
Clause 6: The method of Clause 3, wherein the one or more values comprise a periodicity of the plurality of feedback occasions.
Clause 7: The method of Clause 6, wherein the one or more values comprise a number of the plurality of feedback occasions.
Clause 8: The method of Clause 3, wherein the one or more values comprise a first offset time between a first feedback occasion for transmission of the first feedback and scheduled reception of the first data transmission, and wherein the first offset time and a classification of the UE configure the timing of the plurality of feedback occasions.
Clause 9: The method of any one of Clauses 1-8, wherein the one or more messages comprise one or more of a RRC message, a MAC-CE, or a DCI.
Clause 10: The method of any one of Clauses 1-9, further comprising: receiving at least one uplink grant for one or more uplink resources not dedicated for feedback transmission, wherein the timing for transmission of the first feedback for the first data transmission comprises a time window, and wherein transmitting the first feedback based on the timing comprises transmitting the first feedback in a first uplink resource, of the one or more uplink resources, that occurs during the time window.
Clause 11: The method of Clause 10, wherein the one or more values comprise a non-numerical value or a negative value indicating the time window.
Clause 12: The method of Clause 10, wherein a start time of the time window is defined relative to one of a start time of the first data transmission, an end time of the first data transmission, a start time of a DCI scheduling the first data transmission, or an end time of the DCI scheduling the first data transmission.
Clause 13: The method of Clause 10, further comprising: transmitting an identifier associated with the first data transmission with the first feedback.
Clause 14: The method of Clause 10, wherein the one or more values comprise a first offset time between a first feedback occasion for transmission of the first feedback and scheduled reception of the first data transmission, and wherein the time window starts after the first feedback occasion.
Clause 15: The method of Clause 14, wherein the one or more messages comprise a first message indicating the first offset time and a second message indicating use of the time window.
Clause 16: The method of Clause 10, wherein the one or more values indicate a start time of the time window and an end time of the time window.
Clause 17: The method of Clause 10, wherein the one or more values indicate a start time of the time window and a number of downlink data transmissions defining an end time of the time window.
Clause 18: The method of any one of Clauses 1-17, further comprising: transmitting an indication of a minimum timing gap between a first type of communication by the UE and a second type of communication by the UE, wherein the one or more values comprise a first offset time between a first feedback occasion for transmission of the first feedback and scheduled reception of the first data transmission, wherein the first offset time is based on the minimum timing gap and the recommended minimum offset time.
Clause 19: The method of any one of Clauses 1-18, further comprising: transmitting an indication of whether the UE is capable of both decoding the first data transmission and transmitting the first feedback.
Clause 20: The method of any one of Clauses 1-19, further comprising: transmitting an indication of a number of data transmissions the UE is capable of decoding and a number of feedbacks the UE is capable of transmitting during a time window.
Clause 21: The method of any one of Clauses 1-20, wherein transmitting the first feedback comprises transmitting feedback for a plurality of data transmissions during a first feedback occasion.
Clause 22: The method of Clause 21, wherein the one or more values comprise a periodicity of a plurality of feedback occasions including the first feedback occasion.
Clause 23: The method of Clause 21, wherein transmitting the feedback for the plurality of data transmissions is based on a number of the plurality of data transmissions being greater than a threshold.
Clause 24: The method of Clause 21, wherein transmitting the feedback for the plurality of data transmissions is based on a number of the plurality of data transmissions being less than a threshold and a maximum time limit from receiving at least one of the plurality of data transmissions having been reached.
Clause 25: The method of any one of Clauses 1-24, further comprising: transmitting an indication of a time duration for which the UE can remain active.
Clause 26: The method of Clause 25, wherein the indication of the time duration comprises an index value that maps to the time duration.
Clause 27: The method of any one of Clauses 1-26, further comprising: transmitting, to a network entity, a single bit indication indicating whether the network entity should continue serving the UE.
Clause 28: The method of Clause 27, wherein the single bit indication indicates to stop configuring uplink configured grants for the UE.
Clause 29: The method of any one of Clauses 1-28, wherein the timing for transmission of the first feedback for the first data transmission comprises timing of a plurality of feedback occasions for transmitting the first feedback, and wherein the first feedback is transmitted in a uplink shared channel that occurs in time within a threshold time period after a first feedback occasion and before a second feedback occasion.
Clause 30: The method of any one of Clauses 1-29, further comprising: transmitting one or more bits indicating at least one of: a number of time periods to continue or terminate downlink communication with the UE or a number of time periods to continue or terminate uplink communication with the UE.
Clause 31: The method of any one of Clauses 1-30, wherein the UE is not scheduled for uplink or downlink communications between scheduled reception of the first data transmission and scheduled transmission of the first feedback.
Clause 32: A method for wireless communications by a network entity, comprising: receiving an indication of a recommended minimum offset time, the recommended minimum offset time being a minimum time between communication of feedback for a data transmission and scheduled communication of the data transmission; sending one or more messages indicating one or more values configuring timing for communication of first feedback for a first data transmission; and receiving the first feedback based on the timing for communication of the first feedback.
Clause 33: The method of Clause 32, wherein the one or more values comprise a first offset time between a first feedback occasion for communication of the first feedback and scheduled communication of the first data transmission, wherein the first offset time is greater than or equal to the recommended minimum offset time.
Clause 34: The method of any one of Clauses 32 and 33, wherein the timing for communication of the first feedback for the first data transmission comprises timing of a plurality of feedback occasions for communicating the first feedback.
Clause 35: The method of Clause 34, wherein the one or more values comprise a separate offset time between each of the plurality of feedback occasions and scheduled communication of the first data transmission.
Clause 36: The method of Clause 34, wherein the one or more values comprise: a first offset time between a first feedback occasion for communication of the first feedback and scheduled communication of the first data transmission; and a second offset time between a second feedback occasion of the plurality of feedback occasions and the first feedback occasion.
Clause 37: The method of Clause 34, wherein the one or more values comprise a periodicity of the plurality of feedback occasions.
Clause 38: The method of Clause 37, wherein the one or more values comprise a number of the plurality of feedback occasions.
Clause 39: The method of Clause 34, wherein the one or more values comprise a first offset time between a first feedback occasion for communication of the first feedback and scheduled communication of the first data transmission, and wherein the first offset time and a classification of a UE configure the timing of the plurality of feedback occasions.
Clause 40: The method of any one of Clauses 32-39, wherein the one or more messages comprise one or more of a RRC message, a MAC-CE, or a DCI.
Clause 41: The method of any one of Clauses 32-40, further comprising: transmitting at least one uplink grant for one or more uplink resources not dedicated for feedback transmission, wherein the timing for communication of the first feedback for the first data transmission comprises a time window, and wherein receiving the first feedback based on the timing comprises receiving the first feedback in a first uplink resource, of the one or more uplink resources, that occurs during the time window.
Clause 42: The method of Clause 41, wherein the one or more values comprise a non-numerical value or a negative value indicating the time window.
Clause 43: The method of Clause 41, wherein a start time of the time window is defined relative to one of a start time of the first data transmission, an end time of the first data transmission, a start time of a DCI scheduling the first data transmission, or an end time of the DCI scheduling the first data transmission.
Clause 44: The method of Clause 41, further comprising: receiving an identifier associated with the first data transmission with the first feedback.
Clause 45: The method of Clause 41, wherein the one or more values comprise a first offset time between a first feedback occasion for communication of the first feedback and scheduled communication of the first data transmission, and wherein the time window starts after the first feedback occasion.
Clause 46: The method of Clause 45, wherein the one or more messages comprise a first message indicating the first offset time and a second message indicating use of the time window.
Clause 47: The method of Clause 41, wherein the one or more values indicate a start time of the time window and an end time of the time window.
Clause 48: The method of Clause 41, wherein the one or more values indicate a start time of the time window and a number of downlink data transmissions defining an end time of the time window.
Clause 49: The method of any one of Clauses 32-48, further comprising: receiving an indication of a minimum timing gap between a first type of communication by a UE and a second type of communication by the UE, wherein the one or more values comprise a first offset time between a first feedback occasion for communication of the first feedback and scheduled communication of the first data transmission, wherein the first offset time is based on the minimum timing gap and the recommended minimum offset time.
Clause 50: The method of any one of Clauses 32-49, further comprising: receiving an indication of whether a UE is capable of both decoding the first data transmission and transmitting the first feedback.
Clause 51: The method of any one of Clauses 32-50, further comprising: receiving an indication of a number of data transmissions a UE is capable of decoding and a number of feedbacks the UE is capable of transmitting during a time window.
Clause 52: The method of any one of Clauses 32-51, wherein receiving the first feedback comprises receiving feedback for a plurality of data transmissions during a first feedback occasion.
Clause 53: The method of Clause 52, wherein the one or more values comprise a periodicity of a plurality of feedback occasions including the first feedback occasion.
Clause 54: The method of Clause 52, wherein receiving the feedback for the plurality of data transmissions is based on a number of the plurality of data transmissions being greater than a threshold.
Clause 55: The method of Clause 52, wherein receiving the feedback for the plurality of data transmissions is based on a number of the plurality of data transmissions being less than a threshold and a maximum time limit from transmitting at least one of the plurality of data transmissions having been reached.
Clause 56: The method of any one of Clauses 32-55, further comprising: receiving an indication of a time duration for which a UE can remain active.
Clause 57: The method of Clause 56, wherein the indication of the time duration comprises an index value that maps to the time duration.
Clause 58: The method of any one of Clauses 32-57, further comprising: receiving a single bit indication indicating whether the network entity should continue serving a UE.
Clause 59: The method of Clause 58, wherein the single bit indication indicates to stop configuring uplink configured grants for the UE.
Clause 60: The method of any one of Clauses 32-59, wherein the timing for communication of the first feedback for the first data transmission comprises timing of a plurality of feedback occasions for communicating the first feedback, and wherein the first feedback is transmitted in a uplink shared channel that occurs in time within a threshold time period after a first feedback occasion and before a second feedback occasion.
Clause 61: The method of any one of Clauses 32-60, further comprising: receiving one or more bits indicating at least one of: a number of time periods to continue or terminate downlink communication with a UE or a number of time periods to continue or terminate uplink communication with the UE.
Clause 62: The method of any one of Clauses 32-61, further comprising: refraining from scheduling a UE for uplink or downlink communications between scheduled communication of the first data transmission and scheduled communication of the first feedback.
Clause 63: A processing system, comprising: a memory comprising computer-executable instructions; one or more processors configured to execute the computer-executable instructions and cause the processing system to perform a method in accordance with any one of Clauses 1-62.
Clause 64: A processing system, comprising means for performing a method in accordance with any one of Clauses 1-62.
Clause 65: A non-transitory computer-readable medium comprising computer-executable instructions that, when executed by one or more processors of a processing system, cause the processing system to perform a method in accordance with any one of Clauses 1-62.
Clause 66: A computer program product embodied on a computer-readable storage medium comprising code for performing a method in accordance with any one of Clauses 1-62.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications by a user equipment (UE), comprising:
one or more memories comprising executable instructions; and
one or more processors configured to execute the executable instructions and cause the UE to:
transmit an indication of a recommended minimum offset time, the recommended minimum offset time being a minimum time between transmission of feedback for a data transmission and scheduled reception of the data transmission;
receive one or more messages indicating one or more values configuring timing for transmission of first feedback for a first data transmission; and
transmit the first feedback based on the timing for transmission of the first feedback.

2. The apparatus of claim 1, wherein the one or more values comprise a first offset time between a first feedback occasion for transmission of the first feedback and scheduled reception of the first data transmission, wherein the first offset time is greater than or equal to the recommended minimum offset time.

3. The apparatus of claim 1, wherein the timing for transmission of the first feedback for the first data transmission comprises timing of a plurality of feedback occasions for transmitting the first feedback.

4. The apparatus of claim 3, wherein the one or more values comprise a separate offset time between each of the plurality of feedback occasions and scheduled reception of the first data transmission.

5. The apparatus of claim 3, wherein the one or more values comprise: a first offset time between a first feedback occasion for transmission of the first feedback and scheduled reception of the first data transmission; and a second offset time between a second feedback occasion of the plurality of feedback occasions and the first feedback occasion.

6. The apparatus of claim 3, wherein the one or more values comprise a periodicity of the plurality of feedback occasions.

7. (canceled)

8. The apparatus of claim 3, wherein the one or more values comprise a first offset time between a first feedback occasion for transmission of the first feedback and scheduled reception of the first data transmission, and wherein the first offset time and a classification of the UE configure the timing of the plurality of feedback occasions.

9. (canceled)

10. The method apparatus of claim comprising wherein one or more processors are further configured to execute the executable instructions and cause the UE to:
receive at least one uplink grant for one or more uplink resources not dedicated for feedback transmission,
wherein the timing for transmission of the first feedback for the first data transmission comprises a time window, and
wherein transmitting the first feedback based on the timing comprises transmitting the first feedback in a first uplink resource, of the one or more uplink resources, that occurs during the time window.

11. The apparatus of claim 10, wherein the one or more values comprise a non-numerical value or a negative value indicating the time window.

12. The apparatus of claim 10, wherein a start time of the time window is defined relative to one of a start time of the first data transmission, an end time of the first data transmission, a start time of a downlink control information (DCI) scheduling the first data transmission, or an end time of the DCI scheduling the first data transmission.

13. The apparatus of claim 10, wherein one or more processors are further configured to execute the executable instructions and cause the UE to:
transmit an identifier associated with the first data transmission with the first feedback.

14. The apparatus of claim 10, wherein the one or more values comprise a first offset time between a first feedback occasion for transmission of the first feedback and scheduled reception of the first data transmission, and wherein the time window starts after the first feedback occasion.

15. The apparatus of claim 14, wherein the one or more messages comprise a first message indicating the first offset time and a second message indicating use of the time window.

16. The apparatus of claim 10, wherein the one or more values indicate a start time of the time window and an end time of the time window.

17. The apparatus of claim 10, wherein the one or more values indicate a start time of the time window and a number of downlink data transmissions defining an end time of the time window.

18. The apparatus of claim 1, wherein one or more processors are further configured to execute the executable instructions and cause the UE to:
transmit an indication of a minimum timing gap between a first type of communication by the UE and a second type of communication by the UE, wherein the one or more values comprise a first offset time between a first feedback occasion for transmission of the first feedback and scheduled reception of the first data transmission, wherein the first offset time is based on the minimum timing gap and the recommended minimum offset time.

19. The apparatus of claim 1, wherein one or more processors are further configured to execute the executable instructions and cause the UE to:
transmit an indication of whether the UE is capable of both decoding the first data transmission and transmitting the first feedback.

20. The apparatus of claim 1, wherein one or more processors are further configured to execute the executable instructions and cause the UE to:
transmit an indication of a number of data transmissions the UE is capable of decoding and a number of feedbacks the UE is capable of transmitting during a time window.

21. The method apparatus of claim 1, wherein transmitting the first feedback comprises transmitting feedback for a plurality of data transmissions during a first feedback occasion.

22. The apparatus of claim 21, wherein the one or more values comprise a periodicity of a plurality of feedback occasions including the first feedback occasion.

23. The apparatus of claim 21, wherein transmitting the feedback for the plurality of data transmissions is based on:
a number of the plurality of data transmissions being greater than a threshold; or
a number of the plurality of data transmissions being less than a threshold and a maximum time limit from receiving at least one of the plurality of data transmissions having been reached.

24. (canceled)

25. The apparatus of claim 1 wherein one or more processors are further configured to execute the executable instructions and cause the UE to:
transmit an indication of a time duration for which the UE can remain active.

26. The apparatus of claim 25, wherein the indication of the time duration comprises an index value that maps to the time duration.

27. The apparatus of claim 1, wherein one or more processors are further configured to execute the executable instructions and cause the UE to:
transmit, to a network entity, a single bit indication indicating whether the network entity should continue serving the UE.

28. The apparatus of claim 27, wherein the single bit indication indicates to stop configuring uplink configured grants for the UE.

29. The apparatus of claim 1, wherein the timing for transmission of the first feedback for the first data transmission comprises timing of a plurality of feedback occasions for transmitting the first feedback, and wherein the first feedback is transmitted in a uplink shared channel that occurs in time within a threshold time period after a first feedback occasion and before a second feedback occasion.

30. The apparatus of claim 1, wherein one or more processors are further configured to execute the executable instructions and cause the UE to:
transmit one or more bits indicating at least one of: a number of time periods to continue or terminate downlink communication with the UE or a number of time periods to continue or terminate uplink communication with the UE.

31. The apparatus of claim 1, wherein the UE is not scheduled for uplink or downlink communications between scheduled reception of the first data transmission and scheduled transmission of the first feedback.

32.-62. (canceled)

63. A method for wireless communication by a user equipment (UE), comprising:
transmitting an indication of a recommended minimum offset time, the recommended minimum offset time being a minimum time between transmission of feedback for a data transmission and scheduled reception of the data transmission;
receiving one or more messages indicating one or more values configuring timing for transmission of first feedback for a first data transmission; and
transmitting the first feedback based on the timing for transmission of the first feedback.

64. A network entity configured for wireless communication, comprising: a memory comprising computer-executable instructions; and one or more processors configured to execute the computer-executable instructions and cause the network entity to:
receive an indication of a recommended minimum offset time, the recommended minimum offset time being a minimum time between communication of feedback for a data transmission and scheduled communication of the data transmission;
send one or more messages indicating one or more values configuring timing for communication of first feedback for a first data transmission; and
receive the first feedback based on the timing for communication of the first feedback.
